(19) United States
(12) Patent Application Publication
(10) Pub. No.: US 2025/0232365 A1
(43) Pub. Date: Jul. 17, 2025

(54) SYSTEM AND METHOD FOR BID FLOOR CONTROL

(71) Applicant: Yahoo Ad Tech LLC, New York, NY (US)

(72) Inventors: Miguel Alcobendas, Seal Beach, CA (US); Swarna V Veerapaneni, Ashburn, VA (US); Jonathan Ji, Aldie, VA (US); Dawit D Wami, Woodbridge, VA (US)

(21) Appl. No.: 18/411,082

(22) Filed: Jan. 12, 2024

(51) Int. Cl. G06Q 30/08; H04L 67/306

(52) U.S. Cl. CPC G06Q 30/08; H04L 67/306

(57) ABSTRACT

In an example, responsive to receiving a first content request, a first bid request indicative of a first bid floor may be generated. The first bid request may be transmitted to a first bidder. A first bid response may be received. The first bid response may indicate a first bid for submission to a first auction. Responsive to receiving a second content request, a second bid request indicating a second bid floor different than the first bid floor may be generated. The second bid request may be transmitted to the first bidder. A second bid response may be received. The second bid response may indicate a second bid for submission to a second auction. A bidder profile associated with the first bidder may be determined based upon the first bid floor, the second bid floor, the first bid, the second bid, a first auction result and/or a second auction result.

### BACKGROUND

Many applications, such as websites, applications, etc. may provide platforms for viewing media. For example, a user may interact with a service. While interacting with the service, selected media may be presented to the user automatically.

### SUMMARY

In accordance with the present disclosure, one or more systems, computing devices and/or methods are provided. In an example, in response to receiving a first content request associated with a first content delivery opportunity, a first bid request indicative of a first bid floor may be generated. The first bid request may be transmitted to a first bidder. A first bid response responsive to the first bid request may be received from the first bidder. The first bid response may be indicative of a first bid for submission to a first auction associated with the first content delivery opportunity. A first result of the first auction may be determined. In response to receiving a second content request associated with a second content delivery opportunity, a second bid request indicative of a second bid floor different than the first bid floor may be generated. The second bid request may be transmitted to the first bidder. A second bid response responsive to the second bid request may be received from the first bidder. The second bid response may be indicative of a second bid for submission to a second auction associated with the second content delivery opportunity. A second result of the second auction may be determined. A first bidder profile associated with the first bidder may be determined based upon the first bid floor, the second bid floor, the first bid, the second bid, the first result and/or the second result. The first bidder profile is usable to determine a bid floor associated with the first bidder.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for controlling a bid floors.

FIG. 5A is a component block diagram illustrating an example system in which a content exchange receives a content request in response to a user visiting an internet resource.

FIG. 5B is a component block diagram illustrating an example system in which a content exchange communicates bid requests and/or bid responses to and/or from a set of bidders.

FIG. 5C illustrates an example system in which a client device displays a winning content item.

FIG. 6A is a component block diagram illustrating an example system in which a first subset of content delivery opportunities are assigned to a production bucket and/or a second subset of content delivery opportunities are assigned to a training bucket.

FIG. 6B is a component block diagram illustrating an example system in which a bidder profile is generated.

FIG. 7 is a chart representative of an example of bidding distribution curves associated with various bid floors.

FIG. 8 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

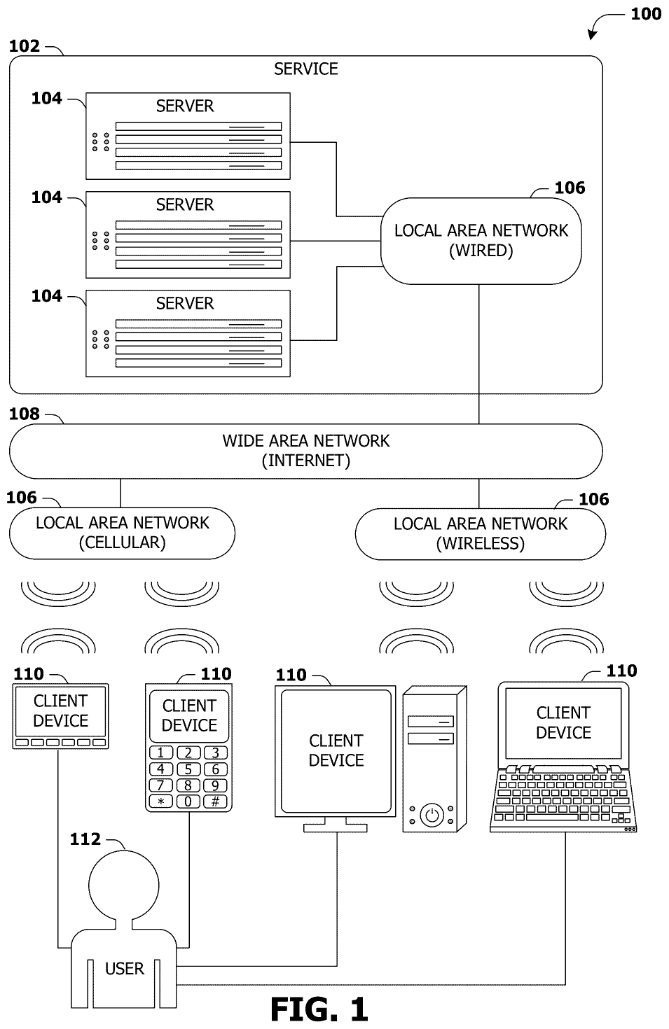

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

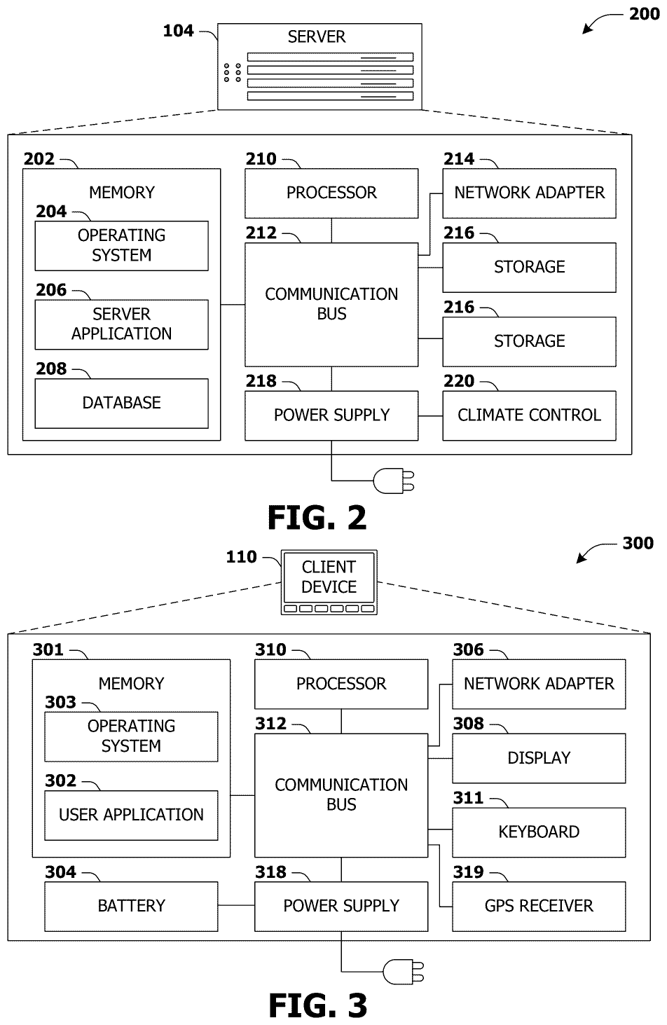

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more computing devices and/or techniques for dynamically controlling bid floors for bidders and/or types of bidders are provided. When hosting an auction (e.g., a first-price auction and/or other type of auction), it may be a challenge to set bid floors (e.g., reserve prices). If bid floors are too high, then the auction may fail to sell a content delivery opportunity, which may lead to a serving location of a web page being empty upon a user visit. If bid floors are too low, then the auction may sell at a lower price than is optimal for a seller. Thus, in accordance with some embodiments, a content system may provide different bid floors to a bidder, and may analyze bid responses responsive to the different bid floors to determine bidding distributions which may identify bidder behavior and/or may be used to predict outcomes (e.g., bid responses and/or auction results) of various bidding floors. The content system may use the bidding distributions to determine bidder profiles indicating updated bid floors for one or more bidders and/or bidder types according to (i) a user associated with the auction (e.g., a user who will see a winning content item of the auction, such as an advertisement or other type of content), (ii) a publisher associated with the auction (e.g., an entity associated with a website visited by the user), (iii) content shown with the winning content item (e.g., content of a web page where the winning content item is shown), etc. The bidder profiles may be used to improve monetization and/or servicing of content delivery opportunities.

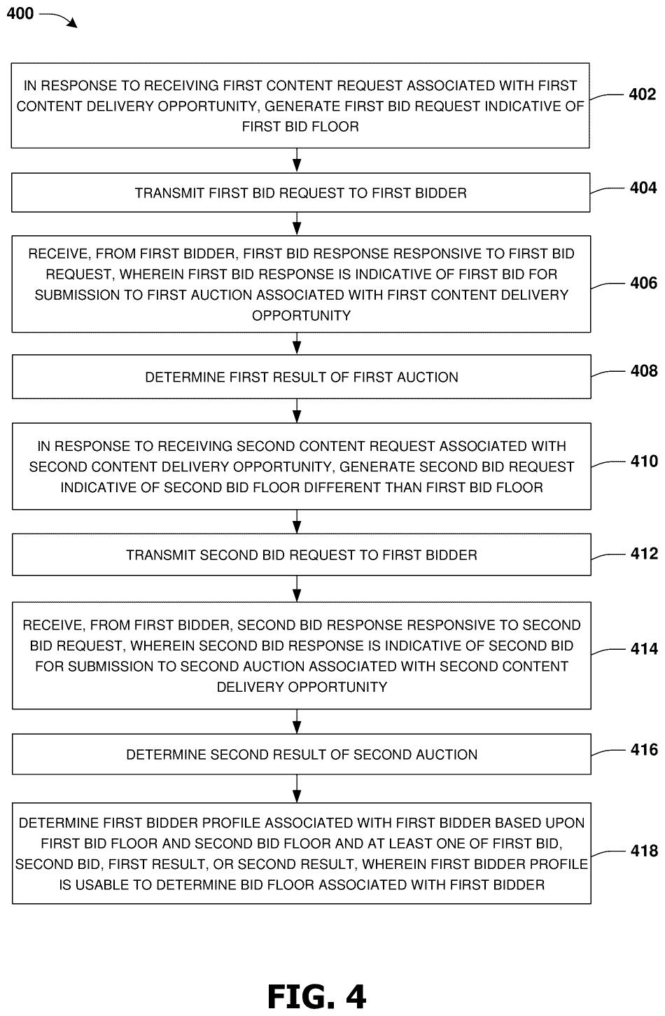

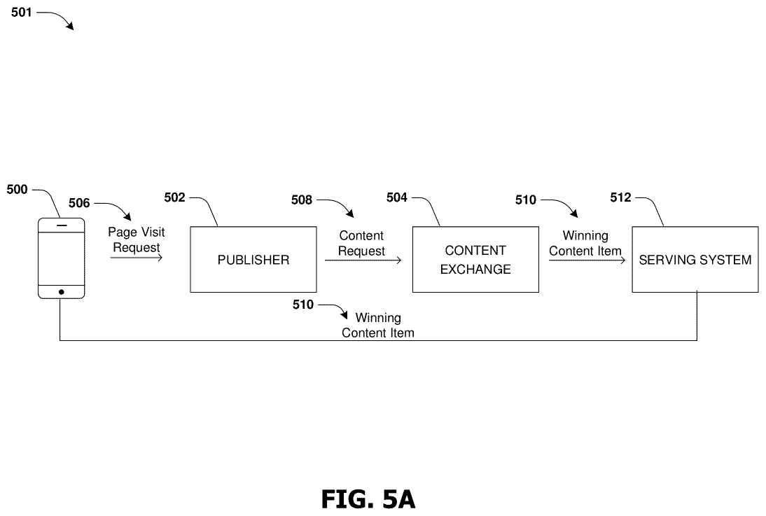

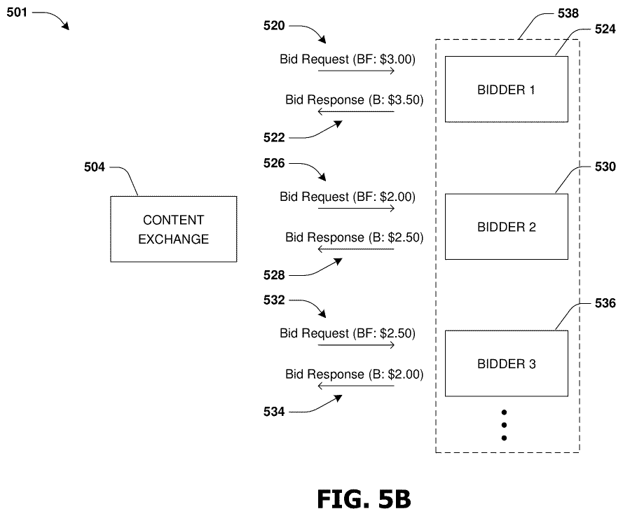

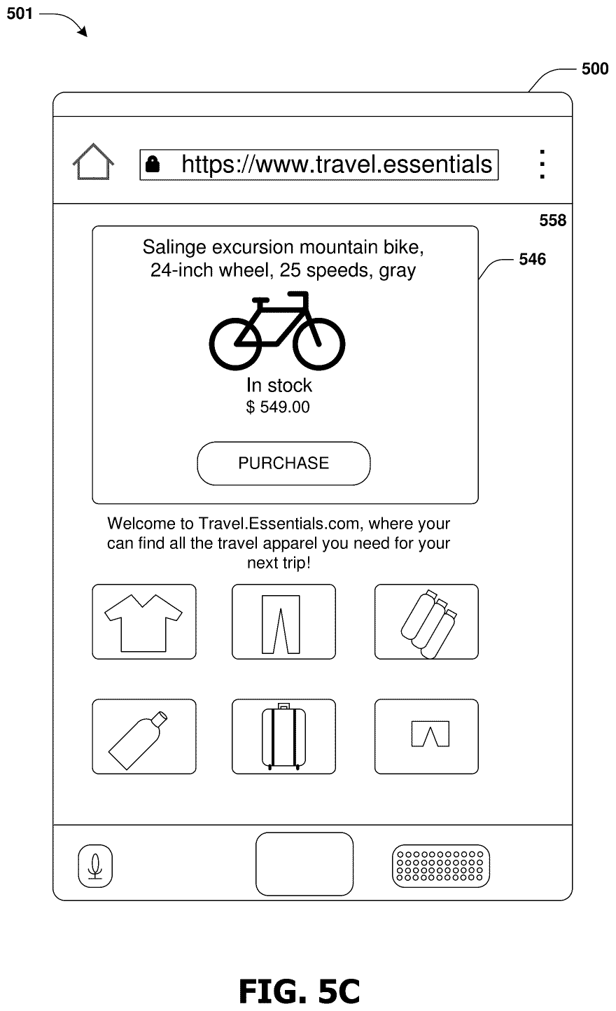

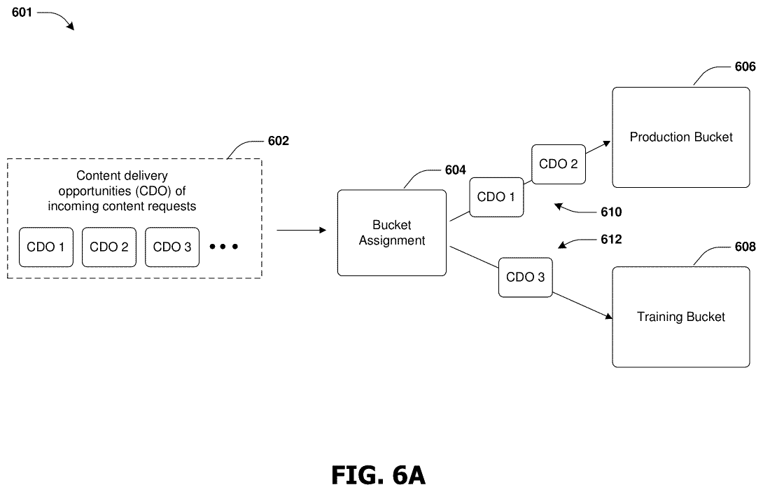

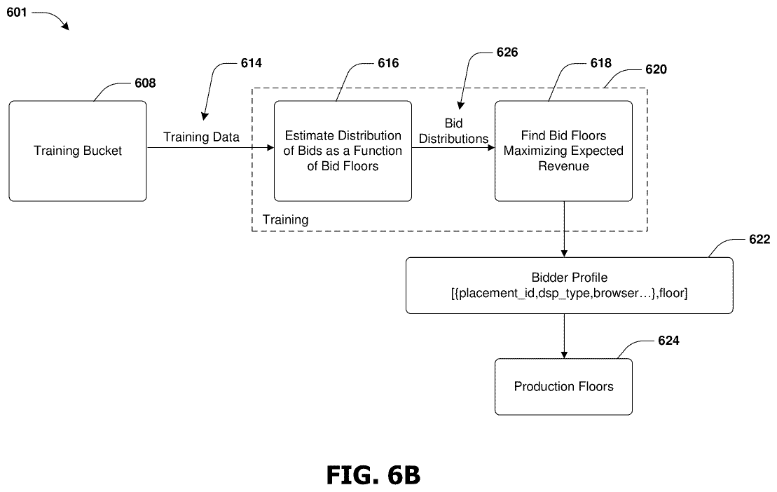

An embodiment of controlling bid floors for bidders and/or types of bidders is illustrated by an example method 400 of FIG. 4, and is further described in conjunction with a system 501 of FIGS. 5A-5D and/or a system 601 of FIGS. 6A-6B. A content system for distributing and/or presenting content via devices may be provided. In some examples, the content system may comprise an advertisement system (e.g., an online advertising system). Alternatively and/or additionally, the content system may not comprise an advertisement system. In some examples, the content system may provide content items to be presented via pages associated with the content system. For example, the pages may be associated with websites (e.g., websites providing search engines, email services, news content, communication services, etc.) associated with the content system. The content system may provide content items to be presented in serving locations (e.g., dedicated advertisement locations) throughout the pages (e.g., one or more areas of the pages configured for presentation of content items, such as advertisements). For example, a content item may be presented at the top of a web page associated with the content system (e.g., within a banner area), at the side of the web page (e.g., within a column), in a pop-up window, overlaying content of the web page, etc. Alternatively and/or additionally, a content item may be presented within an application associated with the content system and/or within a game associated with the content system. Alternatively and/or additionally, a user may be required to watch and/or interact with the content item before the user can access content of a web page and/or video stream application, utilize resources of an application and/or play a game.

The content system may receive a first content request (e.g., an ad call) associated with a first content delivery opportunity. In some examples, the first content delivery opportunity may correspond to an opportunity to provide a content item (e.g., an advertisement and/or other type of content item) to a first client device associated with a first user. For example, the first content delivery opportunity may correspond to an opportunity to present a content item via a first serving location of a first internet resource (e.g., a web page and/or mobile application) on the first client device. The first client device may comprise at least one of a phone (e.g., a smartphone), a tablet, a laptop, a computer, a wearable device, a smart device, a television, any other type of computing device, hardware and/or software. The content system may receive the first content request in response to the first client device accessing (and/or requesting to access) the first internet resource. In an example, the first client device may transmit a request to access the first internet resource to a server associated with the first internet resource. In response to receiving the request to access the first internet resource, the server associated with the first internet resource may transmit the first content request to the content system (and/or to a server associated with the content system). Alternatively and/or additionally, the first content request may be received from the first client device. In some examples, the first content request may correspond to a request to be provided with a content item (e.g., an advertisement, an image, a link, a video, etc.) for presentation via the first serving location of the first internet resource.

FIG. 5A illustrates reception of the first content request (shown with reference number 508) by a content exchange 504 of the content system. For example, the first client device (shown with reference number 500) may transmit the request (shown with reference number 506) to access the first internet resource (e.g., a request to access a web page comprising the first serving location) to the server (shown with reference number 502) associated with the first internet resource (e.g., a publisher). In response to the request 506, the server 502 may transmit the first content request 508 to the content exchange 504. In some examples, the content exchange 504 may provide an indication of winning content item 510 associated with the first content delivery opportunity to a serving system 512 (of the content system, for example). The serving system 512 may provide the winning content item 510 for display on the first client device 500.

At 402, in response to receiving the first content request 508 associated with the first content delivery opportunity, the content system may generate a first bid request. The first bid request may be indicative of a first bid floor (e.g., a reserve price) and a first set of features (e.g., a first set of one or more features) associated with the first content delivery opportunity. For example, the first set of features may comprise (i) an internet resource identifier of the first internet resource (e.g., a web address, such as a uniform resource locator (URL) of the first internet resource) and/or content provided by the first internet resource, (ii) a size of the first serving location (e.g., a size of a content item that can be presented via the first serving location), (iii) a type of content to be displayed via the first serving location (e.g., a type of content, such as video, image, link, etc. requested by the first content request 508), (iv) a type of device of the first client device 500, (v) a browser used by the first client device 500 to access the first internet resource, (vi) a user identifier associated with the first user and/or a first user account of the first user, (vii) a device and/or network identifier (e.g., IP address, Medium Access Control (MAC) address, etc.) associated with the first client device 500, (viii) a time (e.g., time of day at a time zone associated with the first client device 500), (ix) a serving location identifier of the first serving location, (x) an operating system of the first client device 500, (xi) user information associated with the first user (e.g., demographic information and/or historical internet activity associated with the first user, such as at least one of age, gender, location, etc.), and/or (xii) one or more other features.

The first bid floor may correspond to a minimum bid required to win a first auction associated with the first content delivery opportunity. In some examples, the first bid floor may be associated with a first bidder (e.g., the first bid floor may correspond to a minimum bid required for the first bidder to win the first auction). For example, the first bid floor may correspond to a minimum bid required for a bid response of the first bidder to be considered in the first auction.

At 404, the content system may transmit the first bid request to the first bidder. In some examples, the first bidder is at least one of a content creator, a demand-side platform (DSP), or other entity that bids on content delivery opportunities. In some examples, the first bidder may generate and/or transmit (to the content system, for example) a first bid response in response to the first bid request. For example, the first bid response may be indicative of (i) a first content item (e.g., the first bid response may comprise an identifier of the first content item, a web address to access the first content item and/or a file comprising the first content item), and/or (ii) a first bid for submission to the first auction associated with the first content delivery opportunity. The first bidder may determine the first content item and/or the first bid based upon the first bid floor and/or the first set of features (indicated by the first bid request) associated with the first content delivery opportunity. For example, the first bidder may select the first content item for submission to the content system and/or the first auction based upon a determination that the first user of the first client device 500 is part of a target audience of the first client device 500, which may be determined based upon the first set of features indicated by the first bid request. In an example, the first bidder may match the user identifier associated with the first user to a user profile of a user profile database accessible to the first bidder, and/or may select the first content item based upon the user profile (e.g., based upon a determination that the user profile comprises one or more features matching one or more features of the target audience of the first content item).

At 406, the content system may receive, from the first bidder, the first bid response responsive to the first bid request. FIG. 5B illustrates a scenario in which the content exchange 504 of the content system communicates bid requests and/or bid responses to and/or from a set of bidders 538. Although three bidders of the set of bidders 538 are shown in FIG. 5B, any number of bidders of the set of bidders 538 is contemplated, such as one bidder (e.g., merely the first bidder), two bidders, five bidders, 100 bidders, 1,000 bidders, etc. For example, the content exchange 504 may (i) transmit the first bid request (shown with reference number 520) to the first bidder (shown with reference number 524) and/or receive the first bid response (shown with reference number 522) indicating the first content item and/or the first bid (for submission to the first auction, for example), (ii) transmit a second bid request 526 indicating a second bid floor to a second bidder 530 (e.g., an advertiser, a content creator, a DSP, etc.) and/or receive a second bid response 528 (that is responsive to the second bid request 526, for example) indicating a second content item and/or a second bid (for submission to the first auction, for example), (iii) transmit a third bid request 532 indicating a third bid floor to a third bidder 536 (e.g., an advertiser, a content creator, a DSP, etc.) and/or receive a third bid response 534 (that is responsive to the third bid request 532, for example) indicating a third content item and/or a third bid (for submission to the first auction, for example), and/or (iv) transmit one or more bid requests to one or more other bidders and/or receive one or more bid responses responsive to the one or more bid requests. In some examples, the first bid floor may be different than the second bid floor and/or the third bid floor.

In some examples, one or more bid requests sent by the content exchange 504 for the first content delivery opportunity do not result in a bid response. In an example, the third bidder 536 may determine not to send the third bid response 534 to the content exchange 504 based upon a determination that the third bid floor (e.g., $2.50) is greater than an inventory valuation (e.g., $1.75) of the first content delivery opportunity (e.g., the third bidder 536 may determine that submitting a bid greater than the third bid floor would result in a loss, and thus may determine not to submit a bid for the first content delivery opportunity due to the third bid floor being too high, for example). In some examples, the inventory valuation may correspond to a value of the first content delivery opportunity, such as a maximum amount a potential buyer (e.g., an advertiser) would pay to display the third content item (e.g., an advertisement) to the first user via the first serving location. In some examples, the first bidder 524 providing a bid that is greater than the inventory valuation may result in a loss (since if the bid wins the first auction, the amount to be spent for presenting the third content item via the first content delivery opportunity may be greater than how much the first content delivery opportunity is determined to be worth, for example). Alternatively and/or additionally, the third bidder 536 may provide the third bid response 534 even when the third bid is less than the third bid floor. For example in FIG. 5B, the third bid request 532 may indicate the third bid floor of $2.50, whereas the third bid response 534 indicates the third bid of $2.00.

In some examples, the content system (e.g., the content exchange 504 of the content system) may submit a plurality of bids (e.g., the first bid, the second bid, the third bid, and/or other bids received from other bidders of the set of bidders 538) to the first auction. In some examples, the first auction is run by the content system (e.g., the content exchange 504 of the content system) and/or other device. In some examples, bids that do not meet a bid floor condition (e.g., a condition that a bid meets a corresponding bid floor) may be excluded from the first auction. For example, the third bid may not be considered in the first auction based upon a determination that the third bid (e.g., $2.00) does not meet the third bid floor (e.g., $2.50). Accordingly, the plurality of bids participating in the first auction may not comprise the third bid. Alternatively and/or additionally, bids associated with content items that do not comply with one or more requirements associated with the first serving location may be excluded from the first auction. The first auction is run (by the content system and/or other entity) to determine a first winning bid for the first content delivery opportunity (e.g., an advertisement opportunity) from among the plurality of bids. In some examples, the first winning bid may correspond to a highest bid among the plurality of bids. A first winning content item (e.g., the winning content item 510) associated with the first winning bid may be selected for delivery to the first client device 500. In an example, the first winning content item may correspond to the first content item based upon a determination that the first bid is the highest bid among the plurality of bids. In response to performing the first auction, the first winning content item may be transmitted (by the content system, for example) to the first client device 500 (to be displayed on the first client device 500, for example). FIG. 5C illustrates the first client device 500 displaying the first winning content item (e.g., an advertisement and/or other type of content) via the first serving location (shown with reference number 546) in the first internet resource (e.g., a web page 558).

In some examples, the first auction is a first-price auction in which an amount of compensation for presenting the first winning content item is based upon and/or equal to the first winning bid. In some examples, the first auction has passback enabled such that in response to a passback condition being met, (e.g., the passback condition may be met when (i) there are no qualifying bids, such as when no bid among the plurality of bids meets the bid floor condition and/or (ii) the first auction does not result in a winning bid and/or winning content item to display via the first serving location 546), the content system may perform a passback operation. The passback operation may comprise transmitting a bid request to a third party content exchange. In response to the bid request, the third party content exchange may provide content for display via the first serving location 546 (to monetize the first content delivery opportunity, for example). Other types of auctions of the first auction (e.g., second-price auction, etc.) are within the scope of the present disclosure.

At 408, the content system may determine a first result of the first auction. The first result may comprise (i) the first winning content item, (ii) the first winning bid, (iii) whether the passback operation was triggered by the first auction, (iv) an amount of revenue associated with the first auction (e.g., an amount of revenue received as a result of providing the first winning content item for display on the first client device 500), and/or (v) other information associated with the first auction.

In some examples, the content system may receive a second content request (e.g., an ad call) associated with a second content delivery opportunity. The second content delivery opportunity may correspond to an opportunity to provide a content item to a second client device associated with a second user, such as via a second serving location of a second internet resource (e.g., a web page and/or mobile application) on the second client device. In some examples, the second content request may correspond to a request to be provided with a content item (e.g., an advertisement, an image, a link, a video, etc.) for presentation via the second serving location of the second internet resource.

At 410, in response to receiving the second content request associated with the second content delivery opportunity, the content system may generate a second bid request. The second bid request may be indicative of a second bid floor (e.g., a reserve price) and a second set of features (e.g., a second set of one or more features) associated with the second content delivery opportunity (e.g., (i) an internet resource identifier of the second internet resource and/or content provided by the second internet resource, (ii) a size of the second serving location, (iii) a type of content to be displayed via the second serving location, (iv) a type of device of the second client device, (v) a browser used by the second client device to access the second internet resource, (vi) a user identifier associated with the second user and/or a second user account of the second user, (vii) a device and/or network identifier associated with the second client device, (viii) a time, (ix) a serving location identifier of the second serving location, (x) an operating system of the second client device, (xi) user information associated with the second user, and/or (xii) one or more other features). The second bid floor may correspond to a minimum bid required to win a second auction associated with the second content delivery opportunity. In some examples, the second bid floor may be associated with the first bidder 524 (e.g., the second bid floor may correspond to a minimum bid required for the first bidder 524 to win the second auction). For example, the second bid floor may correspond to a minimum bid required for a bid response of the first bidder 524 to be considered in the second auction.

In some examples, the second bid floor may be different than the first bid floor. In an example, the first bid floor may be $3.00 and/or the second bid floor may be $4.00 (or other value). In some examples, the first bid floor and/or the second bid floor are determined

At 412, the content system may transmit the second bid request to the first bidder 524. In some examples, the first bidder 524 may generate and/or transmit (to the content system, for example) a second bid response in response to the second bid request. For example, the second bid response may be indicative of (i) a second content item (e.g., the second bid response may comprise an identifier of the second content item, a web address to access the second content item and/or a file comprising the second content item), and/or (ii) a fourth bid for submission to the second auction associated with the second content delivery opportunity. The first bidder 524 may determine the second content item and/or the fourth bid based upon the second bid floor and/or the second set of features (indicated by the second bid request) associated with the second content delivery opportunity.

At 414, the content system may receive, from the first bidder 524, the second bid response responsive to the second bid request. In some examples, the content system (e.g., the content exchange 504 of the content system) may submit a second plurality of bids (e.g., the fourth bid, and/or other bids received from other bidders of a set of bidders) to the second auction. In some examples, the second auction is run by the content system (e.g., the content exchange 504 of the content system) and/or other device. The second auction is run to determine a second winning bid for the second content delivery opportunity from among the second plurality of bids. In some examples, the second winning bid may correspond to a highest bid among the second plurality of bids. A second winning content item associated with the second winning bid may be selected for delivery to the second client device. In response to performing the second auction, the second winning content item may be transmitted (by the content system, for example) to the second client device (to be displayed on the second client device, for example). In some examples, the second auction is a first-price auction (and/or other type of auction) and/or may have passback enabled (associated with the third party content exchange, for example).

At 416, the content system may determine a second result of the second auction. The second result may comprise (i) the second winning content item, (ii) the second winning bid, (iii) whether the passback operation was triggered by the second auction, (iv) an amount of revenue associated with the second auction (e.g., an amount of revenue received as a result of providing the second winning content item for display on the second client device), and/or (v) other information associated with the second auction. In some examples, information associated with the first auction (e.g., at least one of the first bid floor, the first bid, the first result, one or more of the first set of features, etc.) and/or information associated with the second auction (e.g., at least one of the second bid floor, the second bid, the second result, one or more of the second set of features, etc.) may be stored in an auction history database of the content system (for later use, for example).

At 418, the content system may determine a first bidder profile associated with the first bidder 524 based upon first bidder information comprising the first bid floor the second bid floor, the first bid, the second bid, the first result, the second result and/or other information associated with the first bidder 524. For example, the first bidder information may be accessed and/or retrieved via the auction history database. The first bidder profile may be usable to determine a bid floor associated with the first bidder 524. In some examples, the first bidder profile may be used to determine a bid floor to send to the first bidder 524 based upon one or more inputs associated with a content delivery opportunity. The one or more inputs may comprise an internet resource identifier of an internet resource, content provided by the internet resource, a serving location size, a content type, a device type, a browser, a user identifier, a device and/or network identifier, a time, a serving location identifier, an operating system, user information, and/or one or more other inputs associated with the content delivery opportunity. In some examples, the first bidder profile is validated (using Tukey's Method and/or other techniques, for example) to confirm that the first bidder profile is consistent with one or more expectations and/or does not have outliers. In some examples, the first bidder profile may be used to determine a bid floor in response to the first bidder profile passing the validation.

In some examples, the content system may determine, based upon the first bidder information, a first distribution of bids of the first bidder 524 as a function of a third set of features comprising (i) bid floor feature (e.g., a bid floor sent to the first bidder 524) and/or (ii) one or more content delivery opportunity features associated with content delivery opportunities for which the first bidder 524 participated in corresponding auctions. The one or more content delivery opportunity features may comprise (i) an internet resource identifier feature and/or a feature associated with content of an internet resource, (ii) a serving location size feature, (iii) a content type feature, (iv) a device type feature, (v) a browser feature, (vi) a user identifier feature, (vii) a device and/or network identifier feature, (viii) a time feature, (ix) a serving location identifier feature, (x) an operating system feature, (xi) a user information feature, and/or (xii) one or more other features).

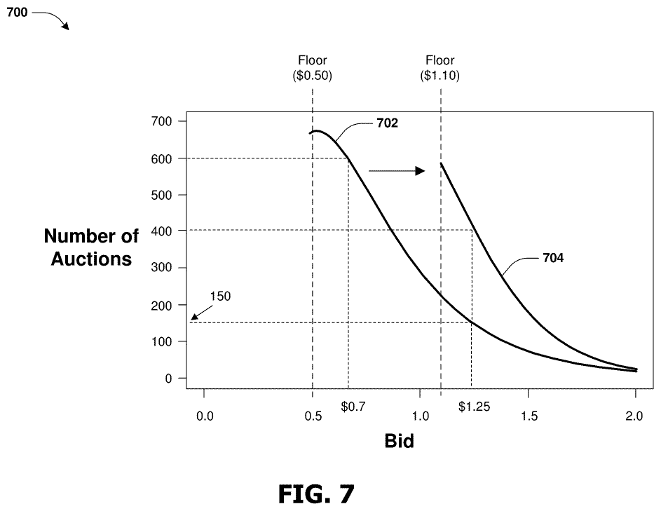

In some examples, the content system determines a plurality of distributions of bids associated with the first bidder 524. Distributions of the plurality of distributions may be associated with different sets of features. In an example, the plurality of distributions associated with the first bidder 524 may comprise (i) the first distribution of bids of the first bidder 524 as a function of the bid floor feature for content delivery opportunities associated with a first website (e.g., content delivery opportunities associated with user visits to web pages of the first website), (ii) a second distribution of bids of the first bidder 524 as a function of the bid floor feature for content delivery opportunities associated with a second website (e.g., content delivery opportunities associated with user visits to web pages of the second website), (iii) a third distribution of bids of the first bidder 524 as a function of the bid floor feature for content delivery opportunities within a first time of day (e.g., content delivery opportunities between 1:00 PM and 5:00 PM), (iv) a fourth distribution of bids of the first bidder 524 as a function of the bid floor feature for content delivery opportunities within a second time of day (e.g., content delivery opportunities between 5:00 PM and 9:00 PM), (v) a fifth distribution of bids of the first bidder 524 as a function of the bid floor feature for content delivery opportunities associated with internet resources of a first publisher, (vi) a sixth distribution of bids of the first bidder 524 as a function of the bid floor feature for content delivery opportunities associated with internet resources of a second publisher, (vii) a seventh distribution of bids of the first bidder 524 as a function of the bid floor feature for content delivery opportunities associated with client devices having a first operating system, (viii) an eighth distribution of bids of the first bidder 524 as a function of the bid floor feature for content delivery opportunities associated with client devices having a second operating system, (ix) a ninth distribution of bids of the first bidder 524 as a function of the bid floor feature for content delivery opportunities associated with client devices having a first browser, (x) a tenth distribution of bids of the first bidder 524 as a function of the bid floor feature for content delivery opportunities associated with client devices having a second browser, (xi) an eleventh distribution of bids of the first bidder 524 as a function of the bid floor feature for content delivery opportunities associated with the first serving location, (xii) a twelfth distribution of bids of the first bidder 524 as a function of the bid floor feature for content delivery opportunities associated with the second serving location, and/or (xiii) other distributions as a function of one or more other features. An example representation of a distribution of bids (e.g., the first distribution of bids and/or other distribution of the plurality of distributions) based upon which the first bidder profile may be determined is shown in FIG. 7. In some examples, a distribution of bids (e.g., the first distribution of bids and/or other distribution of the plurality of distributions) may be generated to (and/or may be assumed to) follow a parametric form (e.g., Weibull Distribution). In some examples, one or more features that characterize a distribution (e.g., the third set of features that characterize the first distribution of bids) may be estimated using data from the auction history database (via maximum likelihood, for example).

In some examples, the first distribution of bids (and/or one or more other distributions of the plurality of distributions) may be used by the content system to generate a first updated bid floor value associated with increased bid values of bid responses from the first bidder 524. In an example, the first updated bid floor value may be generated (e.g., optimized) to (i) maximize expected bid values submitted by the first bidder 524 in response to bid requests indicative of the first updated bid floor value and/or (ii) expected revenue received as a result of sending the first bidder 524 bid requests indicative of the first updated bid floor value in conjunction with content item opportunities. The first updated bid floor value may be included in the first bidder profile.

In some examples, the first bidder profile may comprise a plurality of updated bid floor values (comprising the first updated bid floor value, a second updated vid floor value, etc., for example). Bid floor values of the plurality of updated bid floor values may be associated with sets of features (e.g., the first updated bid floor value may be associated with one or more first features, the second updated bid floor value may be associated with one or more second features, etc.). In an example, the plurality of updated bid floor values associated with the first bidder 524 may comprise (i) the first updated bid floor value to use for content delivery opportunities associated with the first website (e.g., the first updated bid floor value may be determined based upon the first distribution of bids and/or may be used as a bid floor sent to the first bidder 524 in association with content delivery opportunities associated with users visiting web pages of the first website), (ii) the second updated bid floor value (determined based upon the second distribution, for example) to use for content delivery opportunities associated with the second website, (iii) a third updated bid floor value (determined based upon the third distribution, for example) to use for content delivery opportunities within the first time of day, (iv) a fourth updated bid floor value (determined based upon the fourth distribution, for example) to use for content delivery opportunities within the second time of day, (v) a fifth updated bid floor value (determined based upon the fifth distribution, for example) to use for content delivery opportunities associated with internet resources of the first publisher, (vi) a sixth updated bid floor value (determined based upon the sixth distribution, for example) to use for content delivery opportunities associated with internet resources of the second publisher, (vii) a seventh updated bid floor value (determined based upon the seventh distribution, for example) to use for content delivery opportunities associated with client devices having the first operating system, (viii) an eighth updated bid floor value (determined based upon the eighth distribution, for example) to use for content delivery opportunities associated with client devices having the second operating system, (ix) a ninth updated bid floor value (determined based upon the ninth distribution, for example) to use for content delivery opportunities associated with client devices having the first browser, (x) a tenth updated bid floor value (determined based upon the tenth distribution, for example) to use for content delivery opportunities associated with client devices having the second browser, (xi) an eleventh updated bid floor value (determined based upon the eleventh distribution, for example) to use for content delivery opportunities associated with the first serving location, (xii) a twelfth updated bid floor value (determined based upon the twelfth distribution, for example) to use for content delivery opportunities associated with the second serving location, and/or (xiii) other bid values associated with content delivery opportunities associated with other sets of features.

In some examples, the first updated bid floor value (and/or other values of the plurality of updated bid floor values) may be determined using an optimization component associated with optimizing and/or maximizing an objective function, which may capture an expected revenue of a content delivery opportunity. In some examples, the objective function may comprise equation 1:

$$eRev ( ρ \vert X ) = eRevExchangeX ( ρ \vert X ) + Prob ( bids < ρ \vert X ) \times eRevExchange 3 rdP \qquad ( Equation 1 )$$

Equation 1 may capture expected revenue for a content delivery opportunity (eRev(·)) as a function of bid floors ρ and/or a set of features X. In some examples, eRevExchangeX(ρ|X) corresponds to an expected revenue that the content system and/or the content exchange 504 (denoted by ExchangeX) would obtain if one or more of the submitted bids in an auction (e.g., a first-price auction with passback enabled) of the content delivery opportunity is greater than the bid floor (ρ). ρ may correspond to a vector. Each element of one, some and/or all elements of the vector corresponds to a bid floor assigned to a bidder (e.g., a first element of the vector may correspond to the first bid floor assigned to the first bidder 524, a second element of the vector may correspond to the second bid floor assigned to the second bidder 530, etc.). In some examples, eRevExchangeX depends upon one or more distributions of bids (e.g., the plurality of distributions) associated with the first bidder 524 (and/or other distributions of bids associated with other bidders). In some examples, Prob(bids<ρ|X)×eRevExchange3rdP may capture expected return (e.g., expected revenue) from the third party content exchange when bids (e.g., all bids submitted by bidders in association with the content delivery opportunity) are below corresponding bid floors (and/or when the passback condition associated with performing the passback operation is met). In some examples, Prob(bids<ρ|X) may correspond to a probability that bids (e.g., all bids submitted by bidders in association with the content delivery opportunity) are below corresponding bid floors (and/or that the passback condition associated with performing the passback operation is met). In some examples, bids may correspond to a vector with expected bid response of potential bidders.

In some examples, an objective of the content system may be to find a vector of bid floors ρ that maximizes total revenue (e.g., total publisher revenue), which may be determined via equation 2:

$$ρ *= arg max ρ eRev ( ρ \vert X ) \qquad ( Equation 2 )$$

where ρ may be a vector and/or where each element of the vector ρ* may correspond to an optimal bid floor assigned to a bidder. For example, a first element of the vector ρ* may correspond to an optimal bid floor assigned to the first bidder 524 (e.g., the first updated bid floor value and/or other bid floor value determined for the first bidder 524). Alternatively and/or additionally, a second element of the vector ρ* may correspond to an optimal bid floor assigned to the second bidder 530. Thus, the content system may capture different changes in bidder behavior as a response to bid floors. In some examples, the content system implements a mechanism (e.g., a constraint) to guarantee that bid floors are set by type of bidder (e.g., direct bidders, rebroadcasters and/or other types of bidders). Direct bidders (e.g., regular DSPs) may correspond to potential buyers directly bidding in the content exchange 504 on behalf of their clients. Rebroadcasters may correspond to third party exchanges submitting bids in the content exchange 504. Thus, bidder profiles may be determined (using one or more of the techniques provided herein with respect to determining the first bidder profile, for example) for various types of bidders. For example, the first bidder profile may be associated with a first type of bidder (e.g., direct bidders), a third bidder profile may be associated with a second type of bidder (e.g., rebroadcasters), etc. The first bidder profile may be usable to determine a bid floor for transmission to a bidder of the first type of bidder (e.g., the first bidder profile may be used to determine bid floors for some and/or all bidders of the first type of bidder). The third bidder profile may be different than the first bidder profile. The third bidder profile may be usable to determine a bid floor for transmission to a bidder of the second type of bidder (e.g., the third bidder profile may be used to determine bid floors for some and/or all bidders of the second type of bidder). In an example, in response to a content request associated with a content delivery opportunity, the content system may (i) determine a bid floor for the first type of bidder based upon the first bidder profile and transmit bid requests indicating the bid floor (determined based upon the first bidder profile) to one, some and/or all bidders of the first type of bidder, and/or (ii) determine a bid floor for the second type of bidder based upon the third bidder profile and transmit bid requests indicating the bid floor (determined based upon the third bidder profile) to one, some and/or all bidders of the second type of bidder.

In some examples, equation 3 further develops elements of equation 1, and/or shows how expected returns (e.g., revenue) of the content exchange 504 (e.g., eRevExchangeX(·)) and/or the third party content exchange (e.g., eRevExchange3rdP) depend on bidding distribution of bidders and/or participation rate:

$$eRev ( ρ \vert X ) = {\int }_{{G}_{k}} {\sum }_{i ∈ I} [ {k}_{i} {\int }_{ρ i} {b}_{i} {\prod }_{j \neq i} {F}_{j}^{{k}_{j}} ( {b}_{i} \vert {ρ}_{j} , X ) {dF}_{i} ( {b}_{i} \vert {ρ}_{i} , X ) ] {dG}_{k} + eRevExchange 3 rdP {\int }_{{G}_{k}} {\prod }_{i ∈ I} {F}_{i}^{{k}_{i}} ( {ρ}_{i} \vert {ρ}_{i} , X ) {dG}_{k} \qquad ( Equation 3 )$$

where (i) ρ may correspond to the vector of floors (to optimize, for example), (ii) eRev (ρ|X) may correspond to expected revenue of content delivery opportunity as a function of the vector of floors ρ and/or conditional on features X, which may comprise at least one of a publisher (e.g., publisheid), a website (e.g., siteid), a serving location (e.g., placementid), a type of bidder, and/or other features associated with the content delivery opportunity, and/or (iii) Fs(·|ρₛ,X) may correspond to a cumulative distribution function of the bids submitted by bidder s, wherein the distribution depends on the floor set for bidder s (e.g., ρₛ) and/or features X (e.g., Fₛ(u|ρₛ,X) may indicate a probability that the bid submitted by buyer s is lower than u, and/or wherein Fₛ (·|ρₛ,X) may be a function that may be estimated before optimizing Rev (ρ|X), (iv) kₛϵ{0, 1} may correspond to an indicator function that shows if bidder s participates or not in the auction (e.g., kₛ=1 to indicate that the bidder participates in the auction and/or kₛ=0 to indicate that the bidder does not participate in the auction), wherein the participation may come from the multinomial distribution Gₖ that captures the entry probability of bidders, which may be estimated (e.g., it may be assumed that the participation of each bidder follows a Bernoulli distribution with historical observed participation rate as a parameter), wherein an associated integral is simulated using draws (e.g., random draws) from Gₖ, and/or (v) eRevExchange3rdP may correspond to expected revenue when the content delivery opportunity is sent to the third party content exchange (as a result of performing the passback operation responsive to the passback condition being met, for example). In some examples, the content delivery opportunity may be sent to the third party content exchange in response to submitted bids (e.g., all submitted bids) being below the applicable vector of floors ρ with probability ∫_{G}_{ₖ}Π_{iϵI}Fᵢ^{k}^{ᵢ}(ρᵢ|ρᵢ,X)dGₖ. In some examples, historical data is used to determine the value of eRevExchange3rdP.

An expression kᵢ∫_{ρi}bᵢΠ_{j≠i}Fⱼ^{K}^{ⱼ}(bᵢ|ρⱼ,X)dFᵢ(bᵢ|ρᵢ,X) in equation 3 may capture the expected revenue coming from bidder i. In some examples, to win the auction, bidder i's bid (bᵢ) must be both greater than the submitted competing bids and higher than the assigned bid floor ρᵢ. In some examples, conditional on bid bᵢ, bidder i may win with probability Π_{j≠i}Fⱼ^{k}^{ⱼ}(bᵢ|ρⱼ,X). Bid floors may be computed before the auction takes place. In some examples, ex-ante, bi may be unknown to the content exchange 504. Historical data may be used to estimate the bidding distribution Fᵢ(·) and/or compute expected revenue coming from bidder i over the interval [ρ, ∞]. In some examples, total expected return from the auction (eRevExchangeX(·)) (e.g., internal auction) may be a sum of returns coming from each of the potential bidders i in I.

Summand eRevExchange3rdP ∫_{G}_{ₖ}Π_{iϵI}Fᵢ^{k}^{ᵢ}(ρᵢ|ρᵢ,X)dGₖ in equation 3 may capture the expected revenue from the third party content exchange when the content exchange 504 does not have a winner when conducting the auction (and/or when the passback condition is met), which may be in response to submitted bids (e.g., all submitted bids) being below the applicable vector of floors ρ with probability ∫_{G}_{ₖ}Π_{iϵI}Fᵢ^{k}^{ᵢ}(ρᵢ|ρᵢ,X)dGₖ.

In some examples, the first bidder profile comprises a data structure comprising (i) updated bid floor values (e.g., one, some and/or all of the plurality of updated bid floor values), (ii) indications of features associated with the updated bid floor values, and/or (iii) mappings between the updated bid floor values and the indications of features. For example, the first bidder profile may comprise the first updated bid floor value, an indication of the first website associated with the first updated bid floor value, a mapping between the first updated bid floor value and the first website, the second updated bid floor value, an indication of the second website associated with the second updated bid floor value, a mapping between the second updated bid floor value and the second website, etc.

In some examples, the content system may receive a fifth content request associated with a fifth content delivery opportunity. The content system may determine a fifth bid floor based upon the first bidder profile. The fifth bid floor may be different than the first bid floor and/or the second bid floor. The content system (e.g., the content exchange) may transmit a fifth bid request, indicative of the fifth bid floor, to the first bidder 524. In some examples, the first bidder 524 may generate and/or transmit (to the content system, for example) a fifth bid response in response to the fifth bid request. For example, the fifth bid response may be indicative of (i) a fifth content item (e.g., the fifth bid response may comprise an identifier of the fifth content item, a web address to access the fifth content item and/or a file comprising the fifth content item), and/or (ii) a fifth bid for submission to the fifth auction associated with the fifth content delivery opportunity. The first bidder 524 may determine the fifth content item and/or the fifth bid based upon the fifth bid floor and/or a set of features (indicated by the fifth bid request, for example) associated with the fifth content delivery opportunity.

In some examples, the fifth bid floor may be determined based upon a fifth set of features (e.g., a fifth set of one or more features) associated with the fifth content request and/or the fifth content delivery opportunity. The fifth set of features may comprise (i) an internet resource identifier of a fifth internet resource associated with the fifth bid request (e.g., a web page comprising a fifth serving location associated with the fifth content delivery opportunity) and/or content provided by the fifth internet resource, (ii) a size of the fifth serving location, (iii) a type of content to be displayed via the fifth serving location, (iv) a type of device of a fifth client device associated with the fifth content delivery opportunity (e.g., the fifth internet resource may be accessed by the fifth client device), (v) a browser used by the fifth client device to access the fifth internet resource, (vi) a user identifier associated with a user of the fifth client device and/or a user account of the user, (vii) a device and/or network identifier associated with the fifth client device, (viii) a time, (ix) a serving location identifier of the fifth serving location, (x) an operating system of the fifth client device, (xi) user information associated with the user, and/or (xii) one or more other features. In some examples, the fifth bid floor may be set to the first bid floor value in response to determining that the fifth set of features matches a set of features associated with the first bid floor value (e.g., the fifth set of features and/or the set of features comprise one or more features in common), such as based upon a determination that the fifth internet resource is a web page of the first website associated with the first bid floor value and/or based upon a determination that one or more other features of the fifth set of features matches one or more other features associated with the first bid floor value.

In some examples, the first bidder profile may be usable to determine a bid floor (associated with the first bidder 524, for example) during a first period of time (e.g., one or more hours, one or more days, one or more weeks, etc.). In some examples, the content system may receive content requests associated with a plurality of content delivery opportunities. The content requests may be received during the first period of time. The content requests may include the fifth content request and/or the plurality of content delivery opportunities may comprise the fifth content delivery opportunity.

FIG. 6A illustrates content delivery opportunities of the plurality of content delivery opportunities (shown with reference number 602) being assigned to a production bucket 606 and/or a training bucket 608 (e.g., a training bucket). For example, a bucket assignment module 604 may assign a first subset 610 of the plurality of content delivery opportunities 602 to the production bucket 606 and/or may assign a second subset 612 of the plurality of content delivery opportunities 602 to the training bucket 608. In an example, the plurality of content delivery opportunities 602 may comprise content delivery opportunities CDO 1, CDO 2, CDO 3, etc. The first subset 610 to the production bucket 606 may comprise content delivery opportunities CDO 1, CDO 2 and/or one or more other content delivery opportunities. The second subset 612 assigned to the training bucket 608 may comprise content delivery opportunity CDO 3 and/or one or more other content delivery opportunities.

In some examples, the bucket assignment module 604 may be configured to assign a first predefined share of the plurality of content delivery opportunities 602 to the production bucket 606 and/or a second predefined share of the plurality of content delivery opportunities 602 to the training bucket 608. In some examples, the first predefined share may be greater than the second predefined share. In an example, the first predefined share is between about 60% to about 99.5% and/or the second predefined share is between about 0.5% to about 40%. In an example, the first predefined share is about 99% and/or the second predefined share is about 1%, and thus, the first subset 610 assigned to the production bucket 606 may amount to about 99% of the plurality of content delivery opportunities 602 and/or the second subset 612 assigned to the training bucket 608 may amount to about 1% of the plurality of content delivery opportunities 602. Other values of the first predefined share and/or the second predefined share are within the scope of the present disclosure.

In some examples, the fifth bid floor may be determined using the first bidder profile in response to the fifth content delivery opportunity (of the plurality of content delivery opportunities 602, for example) being assigned to the production bucket 606 (e.g., the fifth content delivery opportunity may be included in the first subset 610 assigned to the production bucket 606). Alternatively and/or additionally, for each content delivery opportunity of one, some and/or all content delivery opportunities of the first subset 610, the content system may (i) determine a bid floor using the first bidder profile (using one or more of the techniques provided herein with respect to determining the fifth bid floor, for example) and/or (ii) transmit a bid request comprising the bid floor to the first bidder 524.

In some examples, for each content delivery opportunity of one, some and/or all content delivery opportunities of the second subset 612 assigned to the training bucket 608, the content system may (i) access a bid floor training profile (different than the first bidder profile), (ii) determine a bid floor based upon the bid floor training profile, (iii) transmit a bid request, to the first bidder 524, indicative of the bid floor, (iv) receive, from the first bidder 524, a bid response responsive to the bid request, wherein the bid response is indicative of a bid (determined by the first bidder 524 based upon the bid floor, for example) for submission to an auction (e.g., first-price auction with passback enabled, and/or other type of auction) associated with the content delivery opportunity, and/or (v) determine a result of the auction. In some examples, bid floors transmitted (via bid requests, for example) to the first bidder 524 in association with content delivery opportunities of the second subset 612 may comprise different bid floors such that a behavior of the first bidder 524 can be derived from bid responses sent by the first bidder 524 in response to the bid floors. In some examples, bid floors transmitted (via bid requests, for example) to the first bidder 524 in association with content delivery opportunities of the second subset 612 may comprise random values. For example, a bid floor transmitted (via bid requests, for example) to the first bidder 524 in association with the content delivery opportunity CDO 3 of the second subset 612 may be generated using a floor randomization function of the bid floor training profile, such as a pseudorandom number generator and/or a true random number generator. In some examples, bid floors transmitted (via bid requests, for example) to the first bidder 524 in association with content delivery opportunities of the second subset 612 may be within a predefined range (e.g., between $1.00 and $8.00). In some examples, the predefined range may be input to the floor randomization function, which may generate a random value within the predefined range to use as a bid floor for transmission to the first bidder 524 in association with a content delivery opportunity of the second subset 612. In some examples, the bid floor training profile may be indicative of the predefined range. In some examples, an upper bound of the predefined range is based upon historical bids associated with the first bidder 524 (to avoid an unnecessarily higher bid floor). For example, the upper bound may be set to a percentile (e.g., 95th percentile or other percentile) of the historical bids.

Accordingly, the content system may receive (during the first period of time, for example) a set of bid responses from the first bidder 524 in association with content delivery opportunities of the second subset 612, wherein each of the set of bid responses is responsive to a bid request indicative of a bid floor (e.g., a randomly generated bid floor) determined according to the bid floor training profile. The set of bid responses may be indicative of a set of bids submitted by the first bidder 524 for auctions (e.g., first-price auctions with passback enabled, and/or other type of auctions) associated with content delivery opportunities of the second subset 612. Alternatively and/or additionally, the content system may determine a set of auction results of auctions (performed during the first period of time, for example) performed in association with content delivery opportunities of the second subset 612.

The content system may determine a second bidder profile associated with the first bidder 524 based upon second bidder information comprising (i) a set of bid floors determined using the bid floor training profile for content delivery opportunities of the second subset 612, (ii) the set of bids, from the first bidder 524, associated with content delivery opportunities of the second subset 612 (e.g., each bid of the set of bids may be responsive to a bid floor of the set of bid floors), (iii) the set of auction results associated with content delivery opportunities of the second subset 612, and/or (iv) other information associated with the first bidder 524 and/or content delivery opportunities of the second subset 612. In some examples, the second bidder information may be accessed and/or retrieved via the auction history database.

In some examples, the content system may determine, based upon the second bidder information, one or more first distributions of bids of the first bidder 524 as a function of one or more sets of features comprising (i) a bid floor feature (e.g., a bid floor sent to the first bidder) and/or (ii) one or more content delivery opportunity features associated with content delivery opportunities for which the first bidder 524 participated in corresponding auctions. In some examples, the second bidder profile may be generated based upon the one or more first distributions of bids, such as using one or more of the techniques provided herein with respect to determining the first bidder profile. For example, the second bidder profile may be determined using the optimization component and/or the objective function. In some examples, the second bidder profile corresponds to an updated version of the first bidder profile. In some examples, the second bidder profile comprises (an updated version of) one, some and/or all of the elements, features, data, etc. provided herein with respect to the first bidder profile.

In some examples, the second bidder profile may be usable to determine a bid floor associated with the first bidder 524 during a second period of time after the first period of time. In some examples, the first period of time may correspond to a first day, and the second period of time may correspond to a second day following (e.g., directly following) the first day. In some examples, the second bidder profile may be used (during the second period of time, for example) to determine a bid floor to send to the first bidder 524 based upon one or more inputs associated with a content delivery opportunity (e.g., at least one of an internet resource identifier, content of an internet resource, a serving location size, a content type, a device type, a browser, a user identifier, a device and/or network identifier, a time, a serving location identifier, an operating system, user information, etc. associated with the content delivery opportunity).

FIG. 6B illustrates determination of a bidder profile 610, such as the second bidder profile associated with the first bidder 524. Training data 614 from the training bucket 608 may be submitted to a training module 620. In some examples, the training module 620 may train a model to generate the bidder profile 610. For example, the training module 620 may perform offline training to generate the bidder profile 610. The training module 620 may comprise a bid distribution determination module 616 configured to determine (e.g., estimate) one or more distributions of bids 626 (e.g., the one or more first distributions of bids) based upon the training data 614, which may include data (e.g., bid floors sent to the first bidder 524, bids submitted by the first bidder 524 in response to the bid floors, auction results, etc.) associated with content delivery opportunities assigned to the training bucket 608. In some examples, the training data 614 may include historical data associated with content delivery opportunities over a third period of time, which may be the same as or different than the first period of time. In some examples, the third period of time spans about a week or other duration of time (and/or the first period of time may span about a day). The training module 620 may comprise a profile generation module 618 configured to generate the bidder profile 622 based upon the one or more distributions of bids 626. For example, the profile generation module 618 may determine one or more bid floors based upon the one or more distributions of bids 626 and/or may generate the bidder profile 622 to include the one or more bid floors. In some examples, the one or more bid floors may be used as production floors 624 (for use for content delivery opportunities assigned to the production bucket 606, for example).

In some examples, the training module 620 may be configured to determine a plurality of bidder profiles associated with a plurality of bidders comprising the first bidder 524. For example, bidder profiles of other bidders of the plurality of bidders may be determined using one or more of the techniques provided herein with respect to determining the first bidder profile and/or the second bidder profile associated with the first bidder 524. In some examples, at least some of the plurality of bidder profiles may be determined concurrently. In some examples, the training data 614 comprises data associated with the plurality of bidders.

TABLE 1

| publisherId | siteId | placementId | Direct | Rebroadcaster |
|---|---|---|---|---|
| ABCD | KKKK | AAAA | $0.88 | $1.15 |
| ABCD | KKKK | BBBB | $1.34 | $1.58 |
| ABCD | HHHH | CCCC | $0.57 | $0.75 |
| . . . | . . . | . . . | . . . | . . . |

Table 1 shows a data structure output by the training module 620. The data structure may be indicative of one or more bidder profiles associated with types of bidders including the first type of bidder (e.g., direct bidders) and/or the second type of bidder (e.g., rebroadcasters). The data structure comprises three placement ids (e.g., identifiers of serving locations) and corresponding bid floors for first type of bidder and the second type of bidder. Table 1 shows that for placement ID AAAA (and/or site ID KKKK and/or publisher ID ABCD), the content system may attach (i) a $0.88 bid floor value in a bid request sent to bidders of the first type of bidder (e.g., direct bidders) and/or (ii) $1.15 bid floor value in a bid request sent to bidders of the second type of bidder (e.g., rebroadcasters). Alternatively and/or additionally, for placement ID BBBB (and/or site ID KKKK and/or publisher ID ABCD), the content system may attach (i) a $1.34 bid floor value in a bid request sent to bidders of the first type of bidder (e.g., direct bidders) and/or (ii) $1.58 bid floor value in a bid request sent to bidders of the second type of bidder (e.g., rebroadcasters). Alternatively and/or additionally, for placement ID CCCC (and/or site ID HHHH and/or publisher ID ABCD), the content system may attach (i) a $0.57 bid floor value in a bid request sent to bidders of the first type of bidder (e.g., direct bidders) and/or (ii) $0.75 bid floor value in a bid request sent to bidders of the second type of bidder (e.g., rebroadcasters).

In some examples, various bidder profiles may be generated for various bidders (using one or more of the techniques provided herein with respect to determining the first bidder profile and/or the second bidder profile, for example). For example, (i) a fourth bidder profile may be generated for the second bidder 530 (using one or more of the techniques provided herein with respect to determining the first bidder profile and/or the second bidder profile, for example), (ii) a sixth bidder profile may be generated for the third bidder 536, and/or (ii) other bidder profiles may be generated for the other bidders. In an example, the fourth bidder profile may be different than the first bidder profile and/or the second bidder profile. The fourth bidder profile may be based upon (i) the second bid floor (e.g., $2.00) indicated by the second bid request 526 sent to the second bidder 530 in response to the first content request 508, (ii) the second bid (e.g., $2.50) indicated by the second bid response 528, (iii) a bid floor indicated by a sixth bid request sent to the second bidder 530 in response to the second content request, (iv) a bid indicated by a bid response transmitted by the second bidder 530 in response to the sixth bid request, (v) the first result, (vi) the second result and/or (vii) other information associated with the second bidder 530. The fourth bidder profile may be usable during the first period of time. In an example, in response to a content request associated with a content delivery opportunity (during the first period of time, for example), the content system may (i) determine a bid floor for the first bidder 524 based upon the first bidder profile and transmit a bid request indicating the bid floor (determined based upon the first bidder profile) to the first bidder 524, and/or (ii) determine a bid floor for the second bidder 530 based upon the fourth bidder profile and transmit a bid request indicating the bid floor (determined based upon the fourth bidder profile) to the second bidder 530, wherein the bid floor determined based upon the fourth bidder profile may be different than the bid floor determined based upon the first bidder profile.

In some examples, the content system (e.g., the training module 620 of the content system) may be configured to periodically determine bidder profiles for the first bidder 524 and/or other bidders, such as hourly, daily, weekly, etc. (using one or more of the techniques provided herein with respect to determining the first bidder profile, the second bidder profile and/or the bidder profile 622, for example), thereby providing for more accurate bid floors that may result in increased revenue. Alternatively and/or additionally, the content system may operate according to an agreement with one or more bidders. For example, the agreement may indicate not using intraday bid data to set bid floors. Based upon the agreement, the content system may determine, based upon training data that includes data derived from content delivery opportunities during a current day, a bidder profile indicating updated bid floor values for use during a period of time (e.g., a subsequent day) after the current day.

In some examples, the training module 620 may comprise a first machine learning model used to determine the one or more distributions of bids 626 and/or generate the bidder profile 622. The first machine learning model may, for example, comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc.

In some examples, subsequent to using the first machine learning model to one or more distributions of bids 626 and/or generate the bidder profile 622, the first machine learning model may be updated to generate an updated version of the first machine learning model based upon performance feedback received from the content exchange 504 and/or other component. The performance feedback may be indicative of aspects of the content exchange 504 when the bidder profile 622 is used to determine bid floors provided to one or more bidders. For example, the performance feedback may be indicative of (i) an amount of revenue received, (ii) a quantity of bid requests that result in no bid response from a bidder and/or a bid response indicating a bid less than a corresponding bid floor, and/or (iii) one or more other aspects. In some examples, the first machine learning model may be updated (e.g., trained) by updating trainable parameters of the first machine learning model, using the performance feedback, to generate the updated version of the first machine learning model. In some examples, the updated version of the first machine learning model may be used to (more accurately, for example) determine an updated bidder profile. In this way, a closed-loop process is implemented allowing usage of feedback (e.g., the performance feedback) to tailor the first machine learning model and/or continuously and/or periodically update the first machine learning model used to determine and/or update bidder profiles used to control outgoing bid floors, thereby improving (e.g., continuously and/or periodically improving over time) a quality and/or accuracy of bid floor determination and/or selection and/or presentation of content items for a device. Closed-loop control may reduce errors and produce more efficient operation of a computer system which implements the first machine learning model. The reduction of errors and/or the efficient operation of the computer system may improve operational stability and/or predictability of operation. Accordingly, using processing circuitry to implement closed-loop control described herein may improve operation of underlying hardware of the computer system.

FIG. 7 illustrates a chart 700 representative of a first bid distribution curve 702 and a second bid distribution curve 704. The chart 700 may be representative of how a bidding distribution of a bidder (e.g., the first bidder 524) may change as a result of bid floors sent to the bidder (in bid requests, for example). The horizontal axis displays the bid in dollars per 1000 requests, and the vertical axis shows the number of auctions submitted for a particular bid. In some examples, the first bid distribution curve 702 is representative of a distribution of bids (e.g., a bidding distribution) when an enclosed bid floor in a bid request equals 50 cents. For example, the chart 700 shows that when the bid floor is 50 cents, the bidder participates in 600 auctions with a bid of 70 cents. Since a probability of winning the auction for bids below the bid floor may be equal to zero, it may be assumed that the bidder does not respond with bids below 50 cents (which may be a reason for the distribution being truncated below the bid floor, for example). Bidder bid distributions may change as a result of changes in floors. In some examples, the second bid distribution curve 704 may correspond to a distribution of bids (e.g., a bidding distribution) of the same bidder when the bid floor set by the content exchange 504 is set to $1.10 instead of 50 cents. The bidder may raise its bids as long as they are lower than a corresponding inventory valuation. Accordingly, increasing bid floors (from $0.50 to $1.10, for example) may shift the bid distribution to the right. Higher bid floors may reduce auction participation of bidders because the valuation of some content delivery opportunities may lie between the new higher bid floor (e.g., $1.10) and the original bid floor (e.g., $0.50), and a potential buyer may not have an incentive to bid above the corresponding inventory valuation. For example, the chart 700 shows that with the floor set at $1.10 (e.g., the second bid distribution curve 704), the bidder may participate in 400 auctions when submitting a bid that is equal to $1.25, while we only observe 150 auctions with the same bid when the floor value equals $0.50 (e.g., the first bid distribution curve 702).

Implementation of at least some of the disclosed subject matter may lead to benefits including, but not limited to, reducing a need for manual bid floor management (e.g., marketplace analysis) by the entity, minimizing lost content delivery opportunities, increasing a return-on-investment (ROI) of an entity associated with the content system, etc. For example, the techniques of the present disclosure may be used to automatically (and/or without manual intervention) manage bid floors sent to bidders.

In some examples, the content system comprises a data storage and retrieval system for a first memory (e.g., computer memory) used to store one or more bidder profiles (e.g., the first bidder profile associated with the first bidder 524 and/or the first type of bidder and/or one or more other bidder profiles associated with one or more other bidders and/or types of bidders). The data storage and retrieval system may comprise means for configuring the first memory according to a logical table. The logical table may include a plurality of logical rows, wherein each of the plurality of logical rows includes an object identification number (OID) to identify each of the plurality of logical rows, and/or wherein each of the plurality of logical rows corresponds to a record of information. The logical table may include a plurality of logical columns intersecting the plurality of logical rows to define a plurality of logical cells, each wherein each of the plurality of logical columns include an OID to identify each of the logical columns. The data storage and retrieval system may comprise means for indexing data stored in said table. In some examples, each logical cell of one, some and/or all of the plurality of logical cells stores a current bid floor value (of a bidder profile) to use for a bidder (e.g., the first bidder 524 and/or one or more other bidders). In some examples, in response to determining the first bidder profile, the first bid floor value of the first bidder profile may be stored in a first logical cell of the plurality of logical cells. In some examples, in response to determining the second bidder profile, the data storage and retrieval system clears the first logical cell, and after clearing the first logical cell, the data storage and retrieval system stores an updated bid floor value (of the second bidder profile) in the first logical cell.

In some examples, a second memory of the content system comprises a quarantine sector, a non-quarantine sector and/or a boot sector, wherein the quarantine sector may be isolated from (e.g., physically isolated from) the non-quarantine sector and/or the boot sector. In some examples, code in the quarantine sector may be prevented from performing write actions on other memory sectors, such as the non-quarantine sector and/or the boot sector. In some examples, in response to the content system receiving an electronic communication, the electronic communication is stored in the quarantine sector of the second memory. In some examples, the electronic communication may comprise a content request (e.g., the first content request 508) and/or a bid response. In some examples, the content system extracts (via file parsing, for example) a malicious code from the electronic communication to create a sanitized electronic communication. The extraction of the malicious code may comprise (i) scanning the communication for an identified beginning malicious code marker, (ii) flagging each scanned byte between the beginning marker and a successive end malicious code marker, (iii) continuing scanning until no further beginning malicious code marker is found, and/or (iv) creating a new data file by sequentially copying non-flagged data bytes (e.g., all non-flagged data bytes) into a new file that forms a sanitized communication file. In some examples, the content system transfers the sanitized electronic communication to the non-quarantine sector of the second memory. In some examples, the content system deletes data remaining in the quarantine sector (e.g., the content system deletes all data remaining in the quarantine sector).

In some examples, adaptive monitoring of traffic data through a network appliance connected between computing devices (e.g., the serving system 512 and a fourth client device associated with a content delivery opportunity) is performed. In some examples, the network appliance and/or the serving system 512 collect traffic data relating to the network traffic passing through the network appliance, the traffic data comprising network delay, packet loss, and/or jitter. In some examples, the network appliance and/or the serving system 512 compare at least one of the collected traffic data to a predefined threshold. In some examples, the network appliance and/or the serving system 512 perform one or more acts when the collected traffic data is greater than the predefined threshold. In some examples, the one or more acts comprise collecting additional traffic data relating to the network traffic. In some examples, the additional traffic data comprises protocol data. In some examples, the additional traffic data is exported to a traffic collector to analyze the additional traffic data to determine one or more network issues (e.g., a malfunctioning network component, a source of interference, etc.) and/or facilitate performance of maintenance operations to remedy the one or more network issues. Alternatively and/or additionally, the one or more acts may comprise blocking transmission of a fourth content item (e.g., a content item associated with a winning bid of an auction performed for the content delivery opportunity) to the fourth client device to ease traffic load through the network appliance. In some examples, the fourth content item is transmitted to the fourth client device when the collected traffic data is less than the predefined threshold.

In some examples, the serving system 512 transmits the fourth content item to the fourth client device over one or more cryptographic communications between the serving system 512 and the fourth client device. In some examples, the serving system 512 receives a plaintext word signal. The serving system 512 transforms the plaintext word signal to one or more message block word signals MA. In some examples, the serving system 512 encodes each of the message block word signals MA to produce a ciphertext word signal CA. In some examples, C_{A}=M_{A}^{e} (mod n). In some examples, (i) C_{A} is a number representative of an encoded form of message word M_{A}, (ii) M_{A} corresponds to a number representative of a message, (iii) 0≤M_{A}≤n−1, (iv) n is a composite number of the form n=p*q, (v) p and q are prime numbers, and/or (vi) e is a number relatively prime to (p−1)*(q−1). The serving system 512 may transmit the ciphertext word signal C_{A} to the fourth client device over a communication channel. The ciphertext word signal C_{A} may be indicative of at least a portion of the fourth content item.

In some examples, a third memory of the fourth client device comprises a quarantine sector, a non-quarantine sector and/or a boot sector, wherein the quarantine sector may be isolated from (e.g., physically isolated from) the non-quarantine sector and/or the boot sector. In some examples, code in the quarantine sector may be prevented from performing write actions on other memory sectors, such as the non-quarantine sector and/or the boot sector. In some examples, in response to the fourth client device receiving an electronic communication, the electronic communication is stored in the quarantine sector of the third memory. In some examples, the electronic communication may comprise the fourth content item. In some examples, the fourth client device extracts (via file parsing, for example) a malicious code from the electronic communication to create a sanitized electronic communication. The extraction of the malicious code may comprise (i) scanning the communication for an identified beginning malicious code marker, (ii) flagging each scanned byte between the beginning marker and a successive end malicious code marker, (iii) continuing scanning until no further beginning malicious code marker is found, and/or (iv) creating a new data file by sequentially copying non-flagged data bytes (e.g., all non-flagged data bytes) into a new file that forms a sanitized communication file. In some examples, the fourth client device transfers the sanitized electronic communication to the non-quarantine sector of the third memory. In some examples, the fourth client device deletes data remaining in the quarantine sector (e.g., the fourth client device deletes all data remaining in the quarantine sector). In some examples, the fourth client device renders the fourth content item for display on a screen (e.g., a touchscreen, a monitor, etc.) of the fourth client device using the sanitized electronic communication (e.g., the fourth client device retrieves the sanitized electronic communication from the non-quarantine sector and/or processes information of the sanitized electronic communication to render the fourth content item).

In some examples, the content system serves web pages offering opportunities (e.g., content delivery opportunities, such as commercial opportunities for serving advertisements to users visiting the web pages). The content system may comprise a computer store containing data, for each of a plurality of first web pages, defining a plurality of visually perceptible elements, wherein the plurality of visually perceptible elements correspond to the plurality of first web pages. In some examples, each of the first web pages belongs to one of a plurality of web page owners. In some examples, each of the first web pages displays at least one active link associated with a commerce object associated with a buying opportunity of a selected one of a plurality of merchants. In some examples, the selected merchant, the outsource provider, and the owner of the first web page displaying the associated link are each third parties with respect to one other. The content system may comprise a computer server at the outsource provider, wherein the computer server is coupled to the computer store and programmed to (i) receive from the fourth client device (e.g., a computer and/or a web browser of the computer) a signal indicating activation of one of the links displayed by one of the first web pages, (ii) automatically identify as the source page the one of the first web pages on which the link has been activated, (iii) in response to identification of the source page, automatically retrieve the stored data corresponding to the source page, and/or (iv) using the data retrieved, automatically generate and transmit to the fourth client device (e.g., the computer and/or the web browser) a second web page that displays: (A) information associated with the commerce object associated with the link that has been activated, and (B) the plurality of visually perceptible elements visually corresponding to the source page. For example, the information associated with the commerce object may comprise the fourth content item. Thus, a user of the fourth client device may be able to view both the fourth content item and aspects of the source page.

In some examples, the content system (i) provides a content viewer application to a subscriber for installation on the fourth client device, and/or (ii) receives content items at a transmission server sent from a data source over the Internet, the transmission server comprising a microprocessor and a memory that stores the remote subscriber's preferences for information format, destination address, specified stock price values, and transmission schedule. The microprocessor (i) filters the received content items based upon bids associated with the received content items, wherein one or more bids of the bids are responsive to one or more bid floors provided by the content system, (ii) selects the fourth content item from the filtered content items (based upon a bid associated with the fourth content item being greater than other bids of other content items of the filtered content items, for example), (iii) formats the fourth content item into data blocks according to the information format, and/or (iv) transmits the formatted fourth content item over a wireless communication channel to the fourth client device (e.g., a wireless device) associated with a subscriber based upon the destination address and transmission schedule, wherein the formatted fourth content item activates the content viewer application to cause the fourth content item to display on the remote subscriber computer and/or to enable connection via a universal resource locator (URL) to a data source of the fourth content item over the Internet when the wireless device is locally connected to the remote subscriber computer and the remote subscriber computer comes online.

In some examples, the content system performs a content-loading process for loading the fourth content item into a local computer system (e.g., the fourth client device) which has a system processor and volatile memory and non-volatile memory. In some examples, the content-loading process comprises (i) responding to powering up of the local computer system by requesting, from a memory location (e.g., remote storage location) remote from the local computer system, the transfer to and storage in the volatile memory of the local computer system of the fourth content item, (ii) transferring and/or storing the fourth content item (in the volatile memory, for example) and/or (iii) displaying the fourth content item on a screen of the local computer system.

In some examples, the content system comprises (i) a local client computer (e.g., the fourth client device) generating network access requests for individual controlled access network accounts, (ii) one or more filtering schemes, (iii) a plurality of sets of logical filtering elements, and/or (iv) a remote Internet Service Provider (ISP) server coupled to said client computer and said Internet computer network, said ISP server associating each said network account to at least one filtering scheme and at least one set of filtering elements, said ISP server further receiving said network access requests from said client computer and executing said associated filtering scheme utilizing said associated set of logical filtering elements.

In some examples, the fourth content item comprises an image (e.g., a gray scale image). In some examples, the content system halftones the fourth content item by (i) generating, with a processor, a blue noise mask by encoding changes in pixel values across a plurality of blue noise filtered dot profiles at varying gray levels, (ii) storing the blue noise mask in a first memory location, (iii) receiving a gray scale image and storing the gray scale image in a second memory location, (iv) comparing, with a processor on a pixel-by-pixel basis, each pixel of the gray scale image to a threshold number in the corresponding position of the blue noise mask to produce a binary image array, and/or (iv) converting the binary image array to a halftoned image. In some examples, the halftoned image is transmitted to the fourth client device.

In some examples, at least some of the disclosed subject matter may be implemented on a client device, and in some examples, at least some of the disclosed subject matter may be implemented on a server (e.g., hosting a service accessible via a network, such as the Internet).

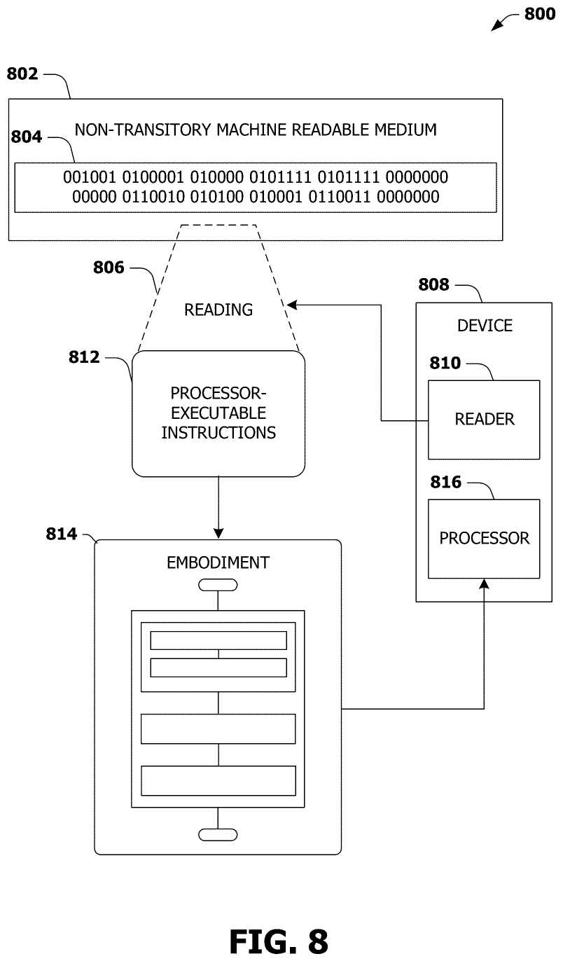

FIG. 8 is an illustration of a scenario 800 involving an example non-transitory machine readable medium 802. The non-transitory machine readable medium 802 may comprise processor-executable instructions 812 that when executed by a processor 816 cause performance (e.g., by the processor 816) of at least some of the provisions herein (e.g., embodiment 814). The non-transitory machine readable medium 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 802 stores computer-readable data 804 that, when subjected to reading 806 by a reader 810 of a device 808 (e.g., a read head of a hard disk drive, or a read operation invoked on a solid-state storage device), express the processor-executable instructions 812. In some embodiments, the processor-executable instructions 812, when executed, cause performance of operations, such as at least some of the example method 400 of FIG. 4, for example. In some embodiments, the processor-executable instructions 812 are configured to cause implementation of a system, such as at least some of the system 501 of FIGS. 5A-5C and/or at least some of the system 601 of FIGS. 6A-6B, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
in response to receiving a first content request associated with a first content delivery opportunity, generating a first bid request indicative of a first bid floor;
transmitting the first bid request to a first bidder;
receiving, from the first bidder, a first bid response responsive to the first bid request, wherein the first bid response is indicative of a first bid for submission to a first auction associated with the first content delivery opportunity;
determining a first result of the first auction;
in response to receiving a second content request associated with a second content delivery opportunity, generating a second bid request indicative of a second bid floor different than the first bid floor;
transmitting the second bid request to the first bidder;
receiving, from the first bidder, a second bid response responsive to the second bid request, wherein the second bid response is indicative of a second bid for submission to a second auction associated with the second content delivery opportunity;
determining a second result of the second auction; and
determining a first bidder profile associated with the first bidder based upon the first bid floor and the second bid floor and at least one of the first bid, the second bid, the first result, or the second result, wherein the first bidder profile is usable to determine a bid floor associated with the first bidder.

2. The method of claim 1, comprising:
receiving a third content request associated with a third content delivery opportunity;
determining a third bid floor, different than at least one of the first bid floor or the second bid floor, based upon the first bidder profile; and
transmitting a third bid request, indicative of the third bid floor, to the first bidder.

3. The method of claim 2, wherein:
the first bidder profile comprises:
a first bid floor value associated with a first set of features; and
a second bid floor value associated with a second set of features; and
determining the third bid floor comprises setting the third bid floor to the first bid floor value in response to determining that a set of features associated with the third content request matches the first set of features.

4. The method of claim 2, comprising:
receiving content requests associated with a plurality of content delivery opportunities;
assigning a first subset of the plurality of content delivery opportunities to a production bucket associated with the first bidder profile;
assigning a second subset of the plurality of content delivery opportunities to a training bucket; and
for each content delivery opportunity of the second subset assigned to the training bucket:
accessing a bid floor training profile different than the first bidder profile;
determining a bid floor based upon the bid floor training profile;
transmitting a bid request, to the first bidder, indicative of the bid floor;
receiving, from the first bidder, a bid response responsive to the bid request, wherein the bid response is indicative of a bid for submission to an auction associated with the content delivery opportunity; and
determining a result of the auction.

5. The method of claim 4, wherein:
assigning the first subset to the production bucket is performed according a first predefined share, of the plurality of content delivery opportunities, to assign to the production bucket; and
assigning the second subset to the production bucket is performed according a second predefined share, of the plurality of content delivery opportunities, to assign to the training bucket.

6. The method of claim 4, wherein:
determining the third bid floor based upon the first bidder profile is performed in response to the third content delivery opportunity being assigned to the production bucket.

7. The method of claim 4, wherein:
determining the bid floor based upon the bid floor training profile comprises generating a random value within a predefined range using a floor randomization function of the bid floor training profile.

8. The method of claim 4, comprising:
determining a second bidder profile associated with the first bidder based upon:
bid floors determined based upon the bid floor training profile for the second subset of content delivery opportunities; and
at least one of:
bids received from the first bidder in association with the second subset of content delivery opportunities; or
results of auctions associated with the second subset of content delivery opportunities.

9. The method of claim 8, wherein the second bidder profile is usable to determine a bid floor associated with the first bidder during a second period of time after a first period of time during which (i) the first bidder profile was usable and (ii) the content requests associated with the plurality of content delivery opportunities were received.

10. The method of claim 1, wherein:
in response to receiving the first content request associated with the first content delivery opportunity, generating a third bid request indicative of a third bid floor;
transmitting the third bid request to a second bidder;
receiving, from the second bidder, a third bid response responsive to the third bid request, wherein the third bid response is indicative of a third bid for submission to the first auction associated with the first content delivery opportunity;
in response to receiving the second content request associated with the second content delivery opportunity, generating a fourth bid request indicative of a fourth bid floor;
transmitting the fourth bid request to the second bidder;
receiving, from the second bidder, a fourth bid response responsive to the fourth bid request, wherein the fourth bid response is indicative of a fourth bid for submission to the second auction associated with the second content delivery opportunity; and
determining a second bidder profile associated with the second bidder based upon the third bid floor and the fourth bid floor and at least one of the third bid, the fourth bid, the first result, or the second result, wherein the second bidder profile is usable to determine a bid floor associated with the second bidder.

11. The method of claim 10, wherein:
the second bidder profile is different than the first bidder profile.

12. The method of claim 11, comprising:
receiving a third content request associated with a third content delivery opportunity;
in response to the third content request:
determining a fifth bid floor associated with the first bidder based upon the first bidder profile;
transmitting a fifth bid request, indicative of the fifth bid floor, to the first bidder;
determining a sixth bid floor associated with the second bidder based upon the second bidder profile, wherein the sixth bid floor is different than the fifth bid floor; and
transmitting a sixth bid request, indicative of the sixth bid floor, to the second bidder.

13. The method of claim 1, comprising:
determining a distribution of bids of the first bidder as a function of one or more features comprising a bid floor feature based upon the first bid floor and the second bid floor and at least one of the first bid, the second bid, the first result, or the second result;
using the distribution of bids to generate an updated bid floor value associated with increased bid values of bid responses from the first bidder; and
including the updated bid floor value in the first bidder profile.

14. A non-transitory machine readable medium having stored thereon processor-executable instructions that when executed cause performance of operations, the operations comprising:
in response to receiving a first content request associated with a first content delivery opportunity, generating a first bid request indicative of a first bid floor;
transmitting the first bid request to a first bidder;
receiving, from the first bidder, a first bid response responsive to the first bid request, wherein the first bid response is indicative of a first bid for submission to a first auction associated with the first content delivery opportunity;
determining a first result of the first auction;
in response to receiving a second content request associated with a second content delivery opportunity, generating a second bid request indicative of a second bid floor different than the first bid floor;
transmitting the second bid request to the first bidder;
receiving, from the first bidder, a second bid response responsive to the second bid request, wherein the second bid response is indicative of a second bid for submission to a second auction associated with the second content delivery opportunity;
determining a second result of the second auction; and
determining a first bidder profile associated with the first bidder based upon the first bid floor and the second bid floor and at least one of the first bid, the second bid, the first result, or the second result, wherein the first bidder profile is usable to determine a bid floor associated with the first bidder.

15. The non-transitory machine readable medium of claim 14, the operations comprising:
receiving a third content request associated with a third content delivery opportunity;
determining a third bid floor, different than at least one of the first bid floor or the second bid floor, based upon the first bidder profile; and
transmitting a third bid request, indicative of the third bid floor, to the first bidder.

16. The non-transitory machine readable medium of claim 15, wherein:
the first bidder profile comprises:
a first bid floor value associated with a first set of features; and
a second bid floor value associated with a second set of features; and
determining the third bid floor comprises setting the third bid floor to the first bid floor value in response to determining that a set of features associated with the third content request matches the first set of features.

17. The non-transitory machine readable medium of claim 15, the operations comprising:
receiving content requests associated with a plurality of content delivery opportunities;
assigning a first subset of the plurality of content delivery opportunities to a production bucket associated with the first bidder profile;
assigning a second subset of the plurality of content delivery opportunities to a training bucket; and
for each content delivery opportunity of the second subset assigned to the training bucket:
accessing a bid floor training profile different than the first bidder profile;
determining a bid floor based upon the bid floor training profile;
transmitting a bid request, to the first bidder, indicative of the bid floor;
receiving, from the first bidder, a bid response responsive to the bid request, wherein the bid response is indicative of a bid for submission to an auction associated with the content delivery opportunity; and
determining a result of the auction.

18. The non-transitory machine readable medium of claim 17, wherein:
assigning the first subset to the production bucket is performed according a first predefined share, of the plurality of content delivery opportunities, to assign to the production bucket; and
assigning the second subset to the production bucket is performed according a second predefined share, of the plurality of content delivery opportunities, to assign to the training bucket.

19. A computing device comprising:
a processor; and
memory comprising processor-executable instructions that when executed by the processor cause performance of operations, the operations comprising:
in response to receiving a first content request associated with a first content delivery opportunity, generating a first bid request indicative of a first bid floor;
transmitting the first bid request to a first bidder;
receiving, from the first bidder, a first bid response responsive to the first bid request, wherein the first bid response is indicative of a first bid for submission to a first auction associated with the first content delivery opportunity;
determining a first result of the first auction;
in response to receiving a second content request associated with a second content delivery opportunity, generating a second bid request indicative of a second bid floor different than the first bid floor;
transmitting the second bid request to the first bidder;
receiving, from the first bidder, a second bid response responsive to the second bid request, wherein the second bid response is indicative of a second bid for submission to a second auction associated with the second content delivery opportunity;
determining a second result of the second auction; and
determining a first bidder profile associated with the first bidder based upon the first bid floor and the second bid floor and at least one of the first bid, the second bid, the first result, or the second result, wherein the first bidder profile is usable to determine a bid floor associated with the first bidder.

20. The computing device of claim 19, the operations comprising:
receiving a third content request associated with a third content delivery opportunity;
determining a third bid floor, different than at least one of the first bid floor or the second bid floor, based upon the first bidder profile; and
transmitting a third bid request, indicative of the third bid floor, to the first bidder.
